(19) United States
(12) Patent Application Publication
(10) Pub. No.: US 2004/0264928 A1
(43) Pub. Date: Dec. 30, 2004

(54) Recording/reproduction apparatus and recording device

(76) Inventors: Chiaki Fujii, Matsuyama-shi (JP); Isao Yamamoto, Nihama-shi (JP); Tomoyasu Amano, Fuchu-shi (JP); Kazuhiko Tomoyasu, Matsuyama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/489,336

(22) PCT Filed: Jun. 24, 2003
(86) PCT No.: PCT/JP03/07958

(51) Int. Cl. H04N 5/781

(52) U.S. Cl. 386/95; 386/125

(57) ABSTRACT

A recording/reproduction apparatus according to the present invention issues a vendor command to a recording device (104) being loaded therein when reading or writing data from/into the recording device (104), and updates last access information that is recorded on a disc (303) in the recording device (104). Further, when the recording device is loaded into a recording/reproduction apparatus other than a dedicated recording/reproduction apparatus that is capable of updating the last access information recorded on the disc (303), the recording device (104) clears the last access information by itself.

The recording/reproduction apparatus that is constructed as described above can recognize whether the presently loaded recording device was accessed last time by a recording/reproduction apparatus other than the dedicated recording/reproduction apparatus.

### TECHNICAL FIELD

The present invention relates to recording/reproduction apparatuses that record or reproduce video signals and audio signals and recording devices that are loaded into the recording/reproduction apparatus and, more particularly, to recording/reproduction apparatuses that can recognize loading histories of recording devices, and the recording devices.

### BACKGROUND ART

As the conventional recording/reproduction apparatus and recording device, a technology that is described in Japanese Published Patent Application No.2000-235774 is known. According to this application, each time a recording device is loaded into a recording/reproduction apparatus, the recording/reproduction apparatus updates loading history information that is stored in the memory of the recording device.

The processing at the loading of the recording device into the conventional recording/reproduction apparatus for updating the loading history recorded in the recording device will be described with reference to FIG. 8.

First, when a recording device having a memory is loaded into a recording/reproduction apparatus, loading of data is performed (step S801). Then, information that is stored in the memory of the recording device is read into a work area (step S802), and the normal recording/reproduction operation is started (step S803).

Subsequently, whether a request to unload the recording device is detected is monitored (step S804). When the unload request is detected, the serial number of the recording/reproduction apparatus is stored in the memory of the recording device to update the loading history (step S805), and then the recording device is unloaded (step S806).

As described above, before the recording device is unloaded from the recording/reproduction apparatus, the loading history stored in the memory of the recording device is updated, whereby the recording device can recognize by itself which recording/reproduction apparatus the recording device has been loaded into and what kind of errors have occurred in the recording device.

However, in the conventional recording/reproduction apparatuses, when the recording device is loaded into an apparatus other than a dedicated recording/reproduction apparatus that is capable of updating the loading history stored in the memory of the recording device, it is impossible to update the loading history. In other words, it cannot be found whether the presently loaded recording device was loaded last time into a dedicated recording/reproduction apparatus or other recording/reproduction apparatus.

In addition, the loading history includes information about the status of an error that has occurred in the recording/reproduction apparatus and information of the recording/reproduction apparatuses into which the recording device has been loaded, thereby facilitating analysis of the error and notifying the state of use of the recording device. However, when an error occurs in a case where the recording device is loaded into an apparatus other than the dedicated recording/reproduction apparatus, the recording device cannot update the status of the error by itself, whereby analysis of the error becomes difficult.

The present invention is made to solve the above-mentioned problems, and has its for object to provide a recording/reproduction apparatus that, when a recording device is loaded therein, can distinguish whether the recording device was accessed last time by the dedicated recording/reproduction apparatus or other recording/reproduction apparatus, and the associated recording device.

### DISCLOSURE OF THE INVENTION

According to claim 1 of the present invention, there is provided a recording/reproduction apparatus that records or reproduces video and audio signals into/from a recording device being loaded, including: when performing data reading or writing from/into the recording device, issuing a command that is unique to the recording device and recording last access information that indicates a last access to the recording device into the recording device. Therefore, by checking the last access information recorded in the recording device being loaded, it is possible to easily judge whether the last access to the recording device being loaded was made by the dedicated recording/reproduction apparatus or by other recording/reproduction apparatus.

According to claim 2 of the present invention, in the recording/reproduction apparatus of claim 1, the video and audio signals are compressed to be recorded into the recording device, and reproduced therefrom to be decompressed. Therefore, a large quantity of data can be efficiently recorded into the recording device.

According to claim 3 of the present invention, in the recording/reproduction apparatus of claim 1, the unique command is a vendor unique. Therefore, it is possible to easily distinguish whether the last access to the recording device was made by the dedicated recording/reproduction apparatus or by other recording/reproduction apparatus.

According to claim 4 of the present invention, in the recording/reproduction apparatus of claim 1, the unique command is a read command, a write command, or a combination of these. Therefore, it is possible to easily distinguish whether the last access to the recording device was made by the dedicated recording/reproduction apparatus or by other recording/reproduction apparatus.

According to claim 5 of the present invention, in the recording/reproduction apparatus of claim 1, the last access information indicates a date and a time when the recording device was accessed last time by the recording/reproduction apparatus. Therefore, it is possible to easily compare the last access information with access information of a time when the recording device was accessed last time.

According to claim 6 of the present invention, in the recording/reproduction apparatus of claim 1, the unique command is issued only when a specific area in the recording device is accessed. Therefore, by checking the last access information recorded in the recording device, it is possible to easily judge whether the last access to the recording device being loaded was made by the dedicated recording/reproduction apparatus or by other recording/reproduction apparatus.

According to claim 7 of the present invention, there is provided a recording device including: a disc for recording last access information that indicates a last access to the recording device by a recording/reproduction apparatus into which the recording device is loaded, and video and audio signals that are transmitted from the recording/reproduction apparatus; and a control unit for updating the last access information when a unique command is issued from the recording/reproduction apparatus, while clearing the last access information by itself when the unique command is not issued from the recording/reproduction apparatus. Therefore, it is possible to easily judge whether the last time access was made by the dedicated recording/reproduction apparatus or not.

According to claim 8 of the present invention, in the recording device of claim 7, the control unit records the last access information in an area on the disc other than a data storage area for recording the video and audio signals. Therefore, it is possible to record the last access information without reducing the data storage area.

According to claim 9 of the present invention, in the recording device of claim 7, the control unit records the last access information in a nonvolatile memory that is provided outside the disc. Therefore, it is possible to record the last access information without using an area on the disc.

According to claim 10 of the present invention, there is provided a recording device including: a disc for recording last access information that indicates a last access to the recording device by a recording/reproduction apparatus into which the recording device is loaded, and video and audio signals that are transmitted from the recording/reproduction apparatus; and a control unit for updating the last access information when a unique command indicating an access to a specific area on the disc is issued from the recording/reproduction apparatus while clearing the last access information when the unique command is not issued from the recording/reproduction apparatus and the specific area on the disc is accessed. Therefore, by checking the last access information, it is possible to easily judge whether a specific area was accessed or not.

According to claim 11 of the present invention, in the recording device of claim 10, the specific area in the recording device is a volume unit. Therefore, it is possible to easily judge whether a specific volume was accessed or not by checking the last access information.

According to claim 12 of the present invention, in the recording device of claim 10, the specific area in the recording device is a folder unit. Therefore, it is possible to easily judge whether a specific folder was accessed or not by checking the last access information.

According to claim 13 of the present invention, in the recording device of claim 10, the specific area in the recording device is a file unit. Therefore, it is possible to easily judge whether a specific file was accessed or not by checking the last access information.

### BRIEF DESCRIPTION OF THE DRAWINGS

FIG. 1 is a block diagram illustrating a recording/reproduction apparatus according to a first embodiment of the present invention.

FIG. 2 is a flowchart for explaining a recording operation of the recording/reproduction apparatus according to the first embodiment.

FIG. 3 is a block diagram illustrating a recording device according to the first embodiment.

FIG. 4 is a flowchart for explaining a recording operation of the recording device according to the first embodiment.

FIG. 5 is a flowchart for explaining a system startup operation according to the first embodiment.

FIG. 6 is a flowchart for explaining a recording operation of a recording/reproduction apparatus according to a second embodiment of the present invention.

FIG. 7 is a flowchart for explaining a recording operation of a recording device according to the second embodiment.

FIG. 8 is a flowchart for explaining an operation of a recording device that is loaded into a conventional recording/reproduction apparatus.

### BEST MODE FOR CARRYING OUT THE INVENTION

Hereinafter, embodiments of the present invention will be described.

### EMBODIMENT

A recording/reproduction apparatus and a recording device according to a first embodiment of the present invention will be described with reference to figures. The recording/reproduction apparatus according to the first embodiment issues a vendor unique command to a recording device that is loaded therein, and records the loading history in an area other than a data storage area in the memory of the recording device.

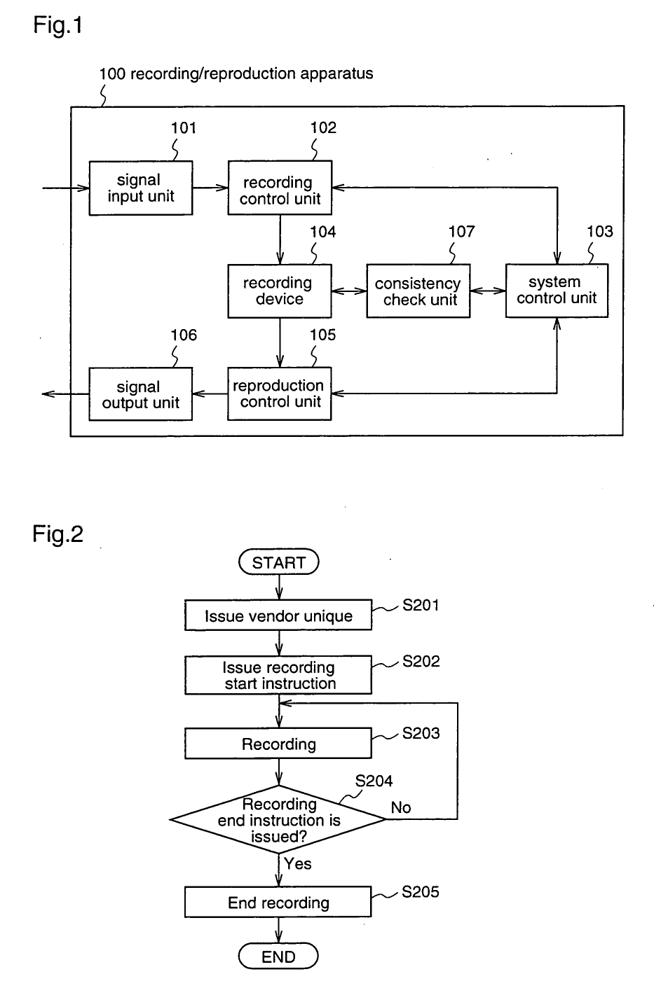

FIG. 1 is a block diagram illustrating a recording/reproduction apparatus according to the first embodiment.

A recording/reproduction apparatus 100 according to the first embodiment comprises a signal input unit 101, a recording control unit 102, a system control unit 103, a detachable recording device 104, a reproduction control unit 105, a signal output unit 106, and a consistency check unit 107.

The signal input unit 101 receives a video signal and an audio signal, and transmits these signals to the recording control unit 102.

The recording control unit 102 compresses the received video and audio signals to transmit the same to the recording device 104, as well as issues a vendor unique to the recording device 104.

The recording device 104 records the compressed video and audio signals that have been transmitted from the recording control unit 102. It is assumed here that a HDD is employed as the recording device 104. Detailed descriptions thereof will be given later.

The reproduction control unit 105 extracts the video and audio signals from the recording device 104, decompresses these signals, and outputs the decompressed signals to the signal output unit 106.

The signal output unit 106 outputs the video and audio signals to outside the recording/reproduction apparatus 100.

The system control unit 103 issues, to the recording control unit 102, a record start instruction that instructs the recording device 104 of an area for recording the video and audio signals and to start recording, and a record end instruction that instructs the recording device 104 to end the recording.

The consistency check unit 107 checks whether there exists necessary information in the recording device 104 at the startup of the recording/reproduction apparatus. Here, the necessary information in the recording device 104, which is checked at the startup of the system, is information about additional information files, and information about volumes, folders and files in the recording device 104.

The additional information file includes information about a storage capacity and an available space of the recording device, the access speed supported by the recording device, the product name or the like of the recording device, the number of directories/folders or the like recorded in the recording device, the recording start time of a recorded file, the playback time and recording position of the recorded file, and the like. Particularly, the information about the playback time and recording position of the recorded file is required at the playback of a video/audio file for performing the special playback (fast forward playback, fast reverse playback, or the like), and this information indicates at which position in the memory of the recording device the video/audio data are recorded at a given playback time.

The operation for starting the recording process in the recording/reproduction apparatus 100 that is constructed as described above will be described with reference FIGS. 2 and 1. FIG. 2 is a flowchart for explaining the recording operation of the recording/reproduction apparatus according to the first embodiment.

Initially, when a recording start instruction is issued from the system control unit 103 to the recording control unit 102, the recording control unit 102 issues a vendor unique to the recording device 104 (step S201), and subsequently issues a recording start instruction to the recording device 104 (step S202). The recording device 104 receives compressed video and audio signals from the recording control unit 102 to perform the recording (step S203), and continues the recording until a recording end instruction is issued from the system control unit 103 (step S204). Then, when the recording end instruction is issued from the system control unit 103 to the recording control unit 102, the recording control unit 102 issues the recording end instruction to the recording device 104, and the recording device 104 ends the recording (step S205).

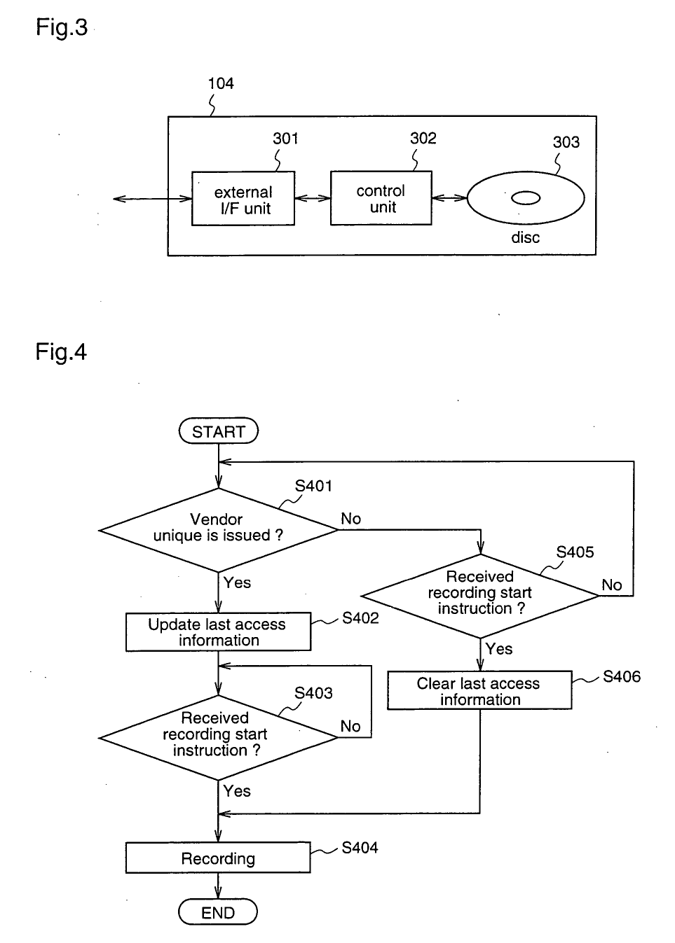

Next, the structure of the recording device 104 will be described. FIG. 3 is a block diagram illustrating the recording device according to the first embodiment.

The recording device 104 includes an external I/F unit 301 that performs input or output of data as well as input of commands, a memory (disc) 303 for recording data, and a control unit 302 that performs analysis of the commands and, when data are to be recorded, reserves an area on the disc 303 for the data while when data are to be reproduced, designating an area of the data on the disc 303.

Operations of the recording device 104 constructed as described above at the data recording and at the data reproduction will be described separately.

When data are to be recorded on the disc 303, a write command is inputted to the control unit 302 through the external I/F unit 301. The control unit 302 analyzes the write command and reserves an area on the disc 303 for recording the data. Then, the data are recorded on the area that is reserved on the disc 303.

On the other hand, when the data recorded on the disc 303 are to be reproduced, a read command is inputted to the control unit 302 through the external I/F unit 301. The control unit 302 analyzes the read command, and then designates an area of the data to be reproduced among various data that are recorded on the disc 303, and extracts the data in the designated area on the disc 303, to output to the recording/reproduction apparatus 100 through the external I/F unit 301.

Next, the operation for recording the last access information in the recording device will be described with reference to FIGS. 4 and 3. FIG. 4 is a flowchart for explaining a recording operation of the recording device according to the first embodiment.

Initially, the control unit 302 monitors whether a vendor unique is issued from the recording control unit 102 (step S401).

When the vendor unique is issued, the control unit 302 judges that the recording device 104 was loaded last time in a dedicated recording/reproduction apparatus, and updates the last access information such as the last access date and time that are recorded in an area on the disc 303 other than an area for recording the data (step S402). Then, when a recording start instruction is issued from the system control unit 103 to the recording control unit 102, the recording device 104 receives the recording start instruction from the recording control unit 102 through the external I/F unit 301 (step S403), and starts recording to the disc 303 (step S404).

On the other hand, when the vendor unique is not issued, the control unit 302 judges that the recording device 104 was loaded last time in a recording/reproduction apparatus other than the dedicated recording/reproduction apparatus, and then the operation proceeds to step S405. In step S405, issuance of a recording start instruction from the system control unit 103 to the recording control unit 102 is waited. When the recording start instruction is issued, the recording device receives the recording start instruction through the external I/F unit 301, clears the last access information that is recorded on the disc 303 (step S406), and starts recording to the disc 303 (step S404).

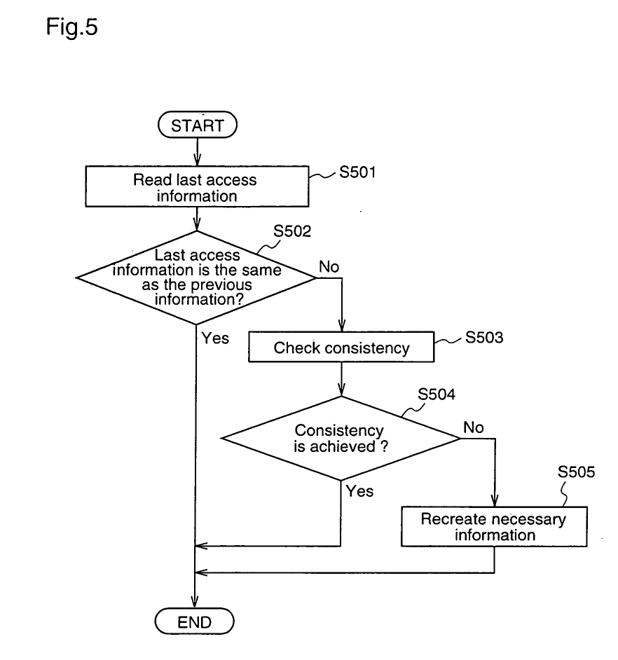

Next, the operation of the consistency check unit 107 will be described with reference to FIG. 5. FIG. 5 is a flowchart for explaining a system startup operation according to the first embodiment.

When the system startup operation is started, the consistency check unit 107 reads the last access information that is recorded on the disc 303 from the recording device 104 (step S501), and judged whether the last access information read from the recording device is the same as the last access information that was recorded last time (step S502).

When the consistency check unit 107 judges in step S502 that the last access information read from the recording device is the same as the last access information that was recorded last time, the processing is ended.

When the unit 107 judges in step S502 that the last access information read from the recording device is different from the previously-recorded last access information, it checks the consistency to confirm that necessary information is recorded in the recording device 104 (step S503). The consistency check unit judges whether the consistency is achieved or not (step S504). When the consistency is achieved, the processing is ended. On the other hand, when the consistency is not achieved, the consistency check unit re-creates necessary information (step S505), and ends the processing.

In this first embodiment, when the recording device 104 is loaded, the vendor unique is issued and the last access information that is stored in the disc 303 of the recording device 104 is updated. Therefore, by confirming the last access information, it is possible to judge whether the presently loaded recording device was accessed last time by the dedicated recording/reproduction apparatus or by other dedicated recording/reproduction apparatus.

Further, in this first embodiment, the last access date/time are recorded as the last access information. Therefore, it is possible to easily compare last access information of an arbitrary recording device, which is held in the recording/reproduction apparatus 100, and the last access information that is stored in the recording device itself.

Further, in this first embodiment, the last access information is recorded in an area other than the data storage area on the disc 303 in the recording device 104. Therefore, it is possible to record the last access information on the disc 303 without reducing the data storage area on the disc 303.

In this first embodiment, when the recording device 104 is loaded into a recording/reproduction apparatus other than the dedicated recording/reproduction apparatus that is capable of updating the last access information recorded on the disc 303, the recording device 104 clears the last access information by itself. Therefore, by confirming the last access information at the system startup, it can be found whether the recording device was accessed by the dedicated recording/reproduction apparatus or by other recording/reproduction apparatus. Accordingly, by checking the consistency of a data file only when the recording device was accessed by other recording/reproduction apparatus, it is possible to reduce the system startup time.

In this first embodiment, the inputted video and audio signals are compressed to be recorded on the disc 303 in the recording device 104, and when the data that are recorded on the disc 303 of the recording device 104 are extracted from the recording device 104, the data are reproduced and decompressed. Therefore, a large number of video and audio signals can be recorded in the recording device.

In this first embodiment, a HDD is used as the recording device 104, while the present invention can be similarly implemented so long as the recording device includes a vendor unique area.

In the first embodiment, the description has been given of the recording operation for recording data in the recording device 104, while a delete operation for deleting data recorded in the recording device 104 or a change operation for changing data recorded in the recording device 104 can be similarly implemented.

In this first embodiment, a vendor unique is taken as an example of a unique command that is issued to the recording device. However, in place of the vendor unique, a command unique to the recording device 104, or a general access command such as a write command or a read command, or combination thereof may be used. For example, it is also possible to issue a write command twice and a read command twice so as to cause an error whenever an access is made. As these commands are general access commands, it is unnecessary to add new commands.

Further, in this first embodiment, the recording/reproduction apparatus 100 issues the vendor unique to the recording device 104 and thereafter starts the recording processing. However, it is also possible that the vendor unique is issued after the recording for the recording device 104 is finished.

In this first embodiment, the last access information is recorded in an area that is different from the data storage area on the disc 303 in the recording device 104. However, it is also possible that the last access information is recorded in a nonvolatile memory that is provided outside the disc 303 of the recording device 104. In this case, the last access information can be recorded without using an area on the disc.

### EMBODIMENT

A recording/reproduction apparatus and a recording device according to a second embodiment of the present invention will be described with reference to the drawing. The recording/reproduction apparatus according to the second embodiment issues a vendor unique when recording data into a specific volume of a memory in a recording device that is loaded in this apparatus. The structure of the recording/reproduction apparatus according to the second embodiment is the same as that shown in FIGS. 1 and 3 as described in the first embodiment.

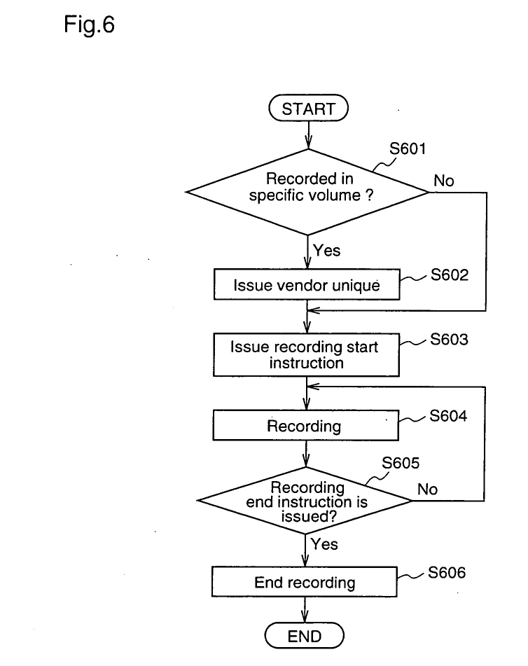

First, the operation of the recording/reproduction apparatus 100 according to the second embodiment for starting a recording operation is described with reference to FIGS. 6 and 1. FIG. 6 is a flowchart for explaining the recording operation of the recording/reproduction apparatus according to the second embodiment.

Initially, when the recording start instruction is issued from the system control unit 103 to the recording control unit 102, the recording control unit 102 judges whether data are to be recorded in a specific volume of the recording device or in other volume of the recording device (step S601).

When it is judged in step S601 that the data are to be recorded in a specific volume, the recording control unit 102 issues a vendor unique to the recording device 104 (step S602), and subsequently issues a recording start instruction to the recording device 104 (step S603).

On the other hand, when it is judged in step S601 that the data are to be recorded not in the specific volume but in other volume, the operation proceeds to step S603. Then, the recording control unit 102 issues a recording start instruction without issuing a vendor unique to the recording device 104.

Next, the recording device 104 receives compressed video and audio signals from the recording control unit 102 through the external I/F unit 301, thereby recording the data on the disc 303 (step S604), and continues the recording until a recording end instruction is issued from the system control unit 103 (step S605). When the recording end instruction is issued from the system control unit 103 to the recording control unit 102, the recording control unit 102 issues a recording end instruction to the recording device 104, and then the recording device 104 ends the recording processing (step S606).

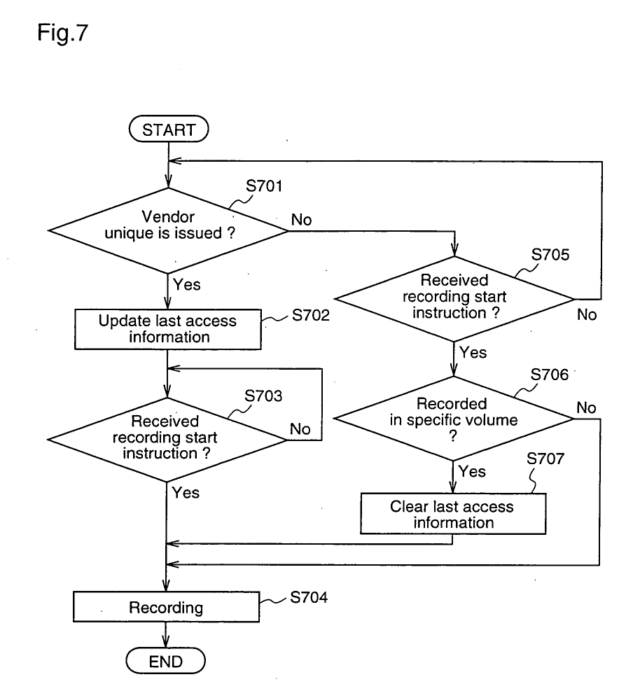

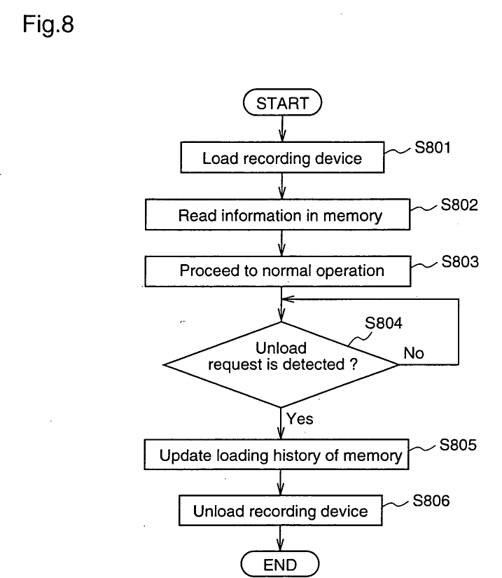

Next, the operation for recording the last access information in the recording device will be described with reference to FIGS. 7, 1, and 3. FIG. 7 is a flowchart for explaining a recording operation of the recording device according to the second embodiment.

Initially, the control unit 302 monitors whether a vendor unique is issued from the recording control unit 102 (step S701).

When the vendor unique is issued, the control unit 302 judges that the recording device 104 was loaded last time into a dedicated recording/reproduction apparatus, and updates the last access information, such as the last access date/time, which is recorded in an area on the disc 303 other than an area for recording data (step S702). Then, it is monitored whether a recording start instruction is issued from the system control unit 103 to the recording control unit 102 (step S703). When the recording start instruction is issued, the recording device receives the recording start instruction from the recording control unit 102 through the external I/F unit 301 to start the recording to the disc 303 (step S704), thereby ending the operation.

On the other hand, when the vendor unique is not issued, the control unit 302 judges that the recording device 104 was loaded last time into a recording/reproduction apparatus other than the dedicated recording/reproduction apparatus, and the operation proceeds to step S705. In step S705, issuance of a recording start instruction from the system control unit 103 to the recording control unit 102 is waited. When the recording start instruction is issued, the recording device receives the recording start instruction through the external I/F unit 301. Then, it is judged whether or not data are to be recorded in a specific volume of the disc 303 in the recording device 104 (step S706).

When it is judged in step S706 that the data are to be recorded in a specific volume, the control unit 302 clears the last access information recorded on the disc 303 (step S707), and starts recording to the disc 303 (step S704).

On the other hand, when it is judged in step S706 that the data are not recorded in a specific volume, the operation proceeds to step S704 to start recording to the disc 303, thereby ending the operation.

In this second embodiment, when data are to be recorded in a specific volume of the disc 303 in the loaded recording device 104, the vendor unique is issued, thereby updating the last access information recorded in the recording device 104. Therefore, by focusing attention on a specific area (i.e., volume), it is possible to find that an area containing necessary information was accessed.

In this second embodiment, when the recording device 104 is loaded in a recording/reproduction apparatus other than the dedicated recording/reproduction apparatus, and when data are to be recorded in a specific volume, the recording device 104 clears the last access information by itself. Therefore, the consistency check unit 107 checks the consistency only when a specific volume is accessed at the system startup, thereby decreasing the number of times of the consistency check after the system startup, and reducing the startup time of the system.

In this second embodiment, a HDD is employed as the recording device 104, while the present invention can be similarly implemented so long as the recording device can use a vendor unique.

Further, in this second embodiment, the description has been given of the recording operation for recording data in the recording device 104. However, a delete operation for deleting data recorded in the recording device 104, or a change operation for changing data recorded in the recording device 104 can be similarly implemented.

In this second embodiment, the recording/reproduction apparatus 100 issues a vendor unique when recording data in a specific volume of the recording device 104, while it may issue a vendor unique when recording data in a specific area, a specific folder, or a specific file of the recording device 104.

Further, in this second embodiment, a vendor unique is taken as an example of a unique command that is issued to the recording device 104, while in place of the vendor unique, a command that is unique to the recording device 104, or a general access command such as a write command or a read command, or combination thereof may be used. For example, it is possible to issue a write command twice and a read command twice so as to cause an error whenever an access is made. Since these commands are general access commands, it is unnecessary to add new commands.

In this second embodiment, the recording/reproduction apparatus 100 starts recording after issuing a vendor unique to the recording device 104. However, the apparatus 100 may issues a vendor unique after finishing the recording for the recording device 104.

In this second embodiment, the last access information is recorded in an area other than a data storage area on the disc 303 of the recording device 104. However, the last access information may be recorded in a nonvolatile memory that is provided outside the disc 303 of the recording device 104. In this case, the recording device 104 can record the last access information without using an area on the disc.

Industrial Availability

The recording/reproduction apparatus and the recording device according to the present invention are available as a recording/reproduction apparatus that can easily detect whether a recording device that is now loaded was loaded last time into a dedicated recording/reproduction apparatus or not.

1. A recording/reproduction apparatus that records or reproduces video and audio signals into/from a recording device being loaded, including:
when performing the data reading or writing from/into the recording device, issuing a command that is unique to the recording device and recording last access information that indicates a last access to the recording device into the recording device.

2. The recording/reproduction apparatus of claim 1 wherein
the video and audio signals are compressed to be recorded into the recording device, and reproduced therefrom to be decompressed.

3. The recording/reproduction apparatus of claim 1 wherein
the unique command is a vendor unique.

4. The recording/reproduction apparatus of claim 1 wherein
the unique command is a read command, a write command, or a combination of these.

5. The recording/reproduction apparatus of claim 1 wherein
the last access information indicates a date and a time when the recording device was accessed last time by the recording/reproduction apparatus.

6. The recording/reproduction apparatus of claim 1 wherein
the unique command is issued only when a specific area in the recording device is accessed.

7. A recording device including:
a disc for recording last access information that indicates a last access to the recording device by a recording/reproduction apparatus into which the recording device is loaded, and video and audio signals that are transmitted from the recording/reproduction apparatus; and
a control unit for updating the last access information when a unique command is issued from the recording/reproduction apparatus, while clearing the last access information by itself when a unique command is not issued from the recording/reproduction apparatus.

8. The recording device of claim 7 wherein
the control unit records the last access information in an area on the disc other than a data storage area for recording the video and audio signals.

9. The recording device of claim 7 wherein
the control unit records the last access information in a nonvolatile memory that is provided outside the disc.

10. A recording device including:
a disc for recording last access information that indicates a last access to the recording device by a recording/reproduction apparatus into which the recording device is loaded, and video and audio signals that are transmitted from the recording/reproduction apparatus; and
a control unit for updating the last access information when a unique command indicating an access to a specific area on the disc is issued from the recording/reproduction apparatus, while clearing the last access information when the unique command is not issued from the recording/reproduction apparatus and the specific area on the disc is accessed.

11. The recording device of claim 10 wherein
the specific area in the recording device is a volume unit.

12. The recording device of claim 10 wherein
the specific area in the recording device is a folder unit.

13. The recording device of claim 10 wherein
the specific area in the recording device is a file unit.
